(19) United States
(12) Patent Application Publication
(10) Pub. No.: US 2019/0255872 A1
(43) Pub. Date: Aug. 22, 2019

(54) Product Marketing Magazine Rider

(71) Applicant: Mark Husmann, Las Vegas, NV (US)

(72) Inventor: Mark Husmann, Las Vegas, NV (US)

(73) Assignees: Fragrance Marketing, LLC, Las Vegas, NV (US); IBMG, LLC, Las Vegas, NV (US)

(21) Appl. No.: 16/405,167

(22) Filed: May 7, 2019

Related U.S. Application Data
(63) Continuation-in-part of application No. 15/166,237, filed on May 26, 2016.
Application No. 15/166,237 is a continuation-in-part of application No. 15/166,251, filed on May 26, 2016.
Application No. 15/166,251 is a continuation-in-part of application No. 15/287,676, filed on Oct. 6, 2016.

(51) Int. Cl. B42D 3/18; B65D 65/02

(52) U.S. Cl. CPC B42D 3/18; B65D 65/02; B42P 2241/20; B42P 2221/06; B42P 2221/08

(57) ABSTRACT

A publication and product delivery package is disclosed which permits a variety of products to be packaged and displayed with a publication, such as a magazine, or an object of similar size, and delivered to a purchaser of that publication in an attractive, efficient, cost effective way, utilizing standard delivery services such as the United States Postal Service. The publication package allows delivery of products and samples which are otherwise loose, liquid, or fragile to arrive intact, despite the stresses and impacts of such packaging, display, and delivery, as the products and samples are affixed to a U.S. Postal Approved marketing “Rider.” The publication package also allows additional high-impact and memorable marketing text and images, which providing exposure of product names and graphics, and coordinated text and images.

### CROSS-REFERENCE AND RELATED APPLICATIONS

This application is a continuation-in-part of pending U.S. applications Ser. Nos. 15/166,237, 15/166,251, and 15/287,676.

### TECHNICAL FIELD OF THE INVENTION

The present invention relates generally to a device and method for the packaging and distribution of products. More specifically, the present invention relates to a device and method which permits a variety of products to be packaged for distribution and displayed while in distribution with a publication, such as a magazine, or an object of similar size. One or multiple products may then be delivered to the purchaser of that publication in an attractive, efficient, cost effective way, utilizing standard delivery services such as the United States Postal Service. The device and method of the present invention allows products which are otherwise loose, liquid, or fragile to survive in their original form, and arrive at the location of the purchaser intact, despite the stresses and impacts of such packaging, display, and delivery. Applicant has secured, from the United States Postal Service, the first ever permit for distribution of such products using Applicants's inventions related to the present invention.

The device and method of the present invention also allows the product manufacturer or distributor to include other additional attractive marketing text and images alongside product containers, in the same “publication package.” These additional text and images achieve a number of purposes, including providing additional exposures of product names, and attractive, marketing graphics. All additional text and images may be coordinated with similar text, images, colors, and overall look and feel of text and images impressed on the delivered products, or on containers which hold the delivered products, all to achieve high-impact and memorable promotion of the products so delivered, with minimal additional delivery costs over those costs of delivering the publication alone when using the United States Postal Service.

Product manufacturers devote considerable time and resources to advertising and promoting their products and, more particularly, to giving away sample trial portions of their products to consumers. Consumers may, with such sample trial portions, examine and even use small amounts of such products, and thereby come to an informed decision about the value and desirability of such products. It is, however, difficult to place even sample trial portions of products into the hands of the desired target market customers along with marketing materials which explain product use and desirability. Direct mail advertising has proven to be an effective means of product promotion, however direct mail advertising is way too costly for most products, even when only small samples are used, and direct mail is often perceived as “junk mail.” When products are received along with a copy of a prestigious publication, perhaps as part of a subscription ordered by a consumer, on the other hand, the association between product and publication is perceived as an endorsement of the product, and so increases its value to the advertiser, the publisher, and the manufacturer of the product so delivered with the publication.

Incorporating a product sample into a publication is a common practice, undertaken by product manufacturers in an effort to join product samples and product advertising. In such cases, the publication is used as a “vehicle” for delivery of the product of the manufacturer. Product manufacturers and advertisers may also more effectively reach a desired group of potential customers by directing their sample products to select publication subscribers. In such a combined publication and product delivery, an advertisement is usually placed within a chosen publication, accompanied by a usually flat sample of a product such as, for example, a fragrance (this is typically referred to as a “scratch and sniff” advertisement, or perhaps a “sachet”). However, due to the limitations of the design of most publications, it is generally impractical to include samples having significant three-dimensional, fragile, or hardened shapes (such as a small glass shampoo bottle), as such shapes may prevent the vehicle publication from fully closing, or prevent it from bending. Even sachets inserted within publications are subjected to considerable stress and impact while the magazine is assembled. Such stresses, which may cause sample containers to rupture, are avoided in the present invention, which adds samples to a publication “post magazine production.” The present invention thereby avoids spreading the sample around and through the publication, and perhaps onto delivery persons and equipment. At the same time, since the present invention allows addition of product samples to the exterior of a publication, many more such samples may be carried with a magazine when delivered, and the volume of such samples correspondingly increased with more numerous and larger samples.

Moreover, samples delivered within publications must be very limited in number and size, as each such additional sample adds to the bulk of a publication, and distorts is shape. Typically, only a single such (small) sample can be carried within magazine. Each such additional therefore makes handling of the publication to be delivered more difficult, as equipment for handing the publication assumes a uniform shape. However, delivery of a large number of samples is desirable, as each new sample is another opportunity for a consumer to directly use a product, perhaps to be convinced if its desirability, with resultant future sales of that product.

Also, highly desirable advertising space within publications is limited, each page being an opportunity to expose a consumer to a product name, and graphics associated with such product, but the number of pages of the publication dedicated to such purpose limited. A way to increase such exposure to marketing materials would be highly desirable for most product manufacturers, but a publishers cannot provide only advertisements, without other content, and the size of the publication is limited by what people can pick up, and what they will read.

Even the position of advertising within publications is critical to effective advertising, with placement of advertising near the front of the publication, or even on its front or back cover, much more desirable than being “buried” within the publication, or appearing late in the publication or lower on its pages.

The present invention is designed to provide a means for distributing sample materials and promotional items efficiently and selectively, therefore providing a more efficient utilization of limited marketing resources, while at the same time protecting such promotional items from breakage. The term “efficiently” includes features which allows multiple samples to be delivered with a publication, and for the same price of delivery, or for a minor additional charge which reflects a beneficial pricing structure of the United States Postal Service (herein referred to as “US Postal Service”). In short, the US Postal Service charges publishers to deliver each copy of a publication, but often charges no more, or very little more, to “handle” a publication which contains on its pages a small package of some consumer product.

The present invention discloses a product sample holder which is lightweight, inexpensive, and efficient, which is designed to be utilized in conjunction with publications as a “rider” or “onsert” or “wrap” (hereafter generally referred to as a “Rider”). That is, the durable holder device of the present invention is included in the same publication package with a selected publication, however the holder device has additional components which stabilize it within the publication package, so that it generally maintains its position, consistent with Postal Service regulations. The position of the Rider of the present invention is covering the delivered publication, either fulling enclosing it, or partially enclosing it.

The “break” in pricing described above for materials which are included in a publication also apply to materials which accompany a publication, so long as the Rider complies with U.S. Postal Service regulations. Because of the new structure of the present invention, it is consistent with such regulations, and does not require a special permit, or the authorization granted by the U.S. Postal Service like applicant's other inventions.

Publications which are chosen as “vehicle” publications for delivery using the holder device of the present invention may therefore have a wide variety of forms, from a generally square, glued binding, or tapered and stapled bindings, or no binding at all. The only shape requirement for the holder device of the present invention is that the vehicle publication have the attributes of a standard publication (typically a magazine), such as a sufficient number of pages to give the publication sufficient rigidity that it will not collapse within the outer cover of the publication package.

The design of the holder device of the present invention permits easy insertion of product samples onto the holder, generally securing small packages of the samples by adhesive to one or more “pages” of paper or plastic, which paper or plastic is somewhat more rigid than the pages of the publication to be delivered. Such page material is not limited in its thickness and rigidity because the U.S. Postal Service does not charge extra for thicker, stiffer, and heaver material. However, a “card stock” which is similar in thickness to the cover of the delivered publication is optimal because it is perceived to be “part of the magazine,” thereby taking on the gravitas of the publication in the minds of many consumers. Such card stock is also highly desirable for its ability to accept sophisticated means to apply high quality images in the marketing which is impressed on the front side and the back side of each page of stock.

Once the marketing pages and product samples are assembled, and the assembled combination of marketing pages and samples are joined with a publication to be delivered (generally by enclosing it entirely or in part), the assembled combination is then again enclosed within a single product package (i.e., with magazine, marketing pages, and product sample packages) by “poly-bagging,” or “shrink wrap,” or other outer cover means. Once the product package has been sealed within an outer cover, the entire assembly of the present invention is consistent with standard publication delivery methods, such as direct mail, newsstand distribution, and U.S. Postal Service delivery. Product manufacturers may thereby reach their targeted consumers, who will receive their publication with product samples intact, even if the packages contain fluid samples. Moreover, the apparatus and methodology of the present invention will not damage postal machinery, or contaminate postal customer mail boxes, carrier bags, and the like, with content leakage. As a result, fluids such as fragrances, which are flammable, and loose substances such as glitter, and other difficult-to-transport materials may be transported, even if they would be considered flammable or hazardous in other containers.

Further, the outer cover of some of the preferred embodiments the present invention may be nearly transparent, thereby allowing consumers to easily identify the kinds of samples enclosed therein, or the outer cover may be opaque, thereby allowing consumers to identify only the publication contained within. Or the outer cover may be opaque, and the name of the publication and the names of the samples may be printed on the exterior of the outer cover, thereby allowing consumers to associate the publication and the products to be sampled even before the outer cover is opened (as a consumer might see the publication on a news stand).

With this arrangement of outer cover, enclosing inner marketing pages (which carry sample packages), in turn enclosing the publication itself, consumers have an opportunity to view attractive marketing materials with each step of opening the packaging of the publication on its receipt. The product manufacturer thereby achieves a maximum of advertising space with the publication package of the present invention. All of the advertising space of the outer cover, and of the pages of the Rider, and the sample packages themselves, is viewable, and must even be handled as the consumer receives her magazine. The consumer thereby must view the attractive advertising on the outer cover before opening it, must then view the attractive advertising on the pages of the Rider before the publication is removed from the Rider. The consumer is also given the opportunity to read the names of the product manufactures on the samples attached to the Rider, and pull them from the Rider for use (or for seeing again and again if not immediately used). The consumer is also given the opportunity to view the attractive advertising on the inside (or front side) of the back page (or pages) when the publication has been removed from the Rider, and also view the attractive advertising on the back side of the back page before disposal of the Rider.

All of the advertising appearing on the front and back of the Rider pages may also be coordinated with the advertising on the outer cover, and the sachets samples, and even the front and back covers of the publication to be delivered, thereby insuring overall aesthetic appeal of the selected publication, and maximum advertising impact for product manufacturers when a purchaser detaches the sample packages and Rider pages from the selected publication, and removes product samples for inspection and use.

### DISCLOSURE OF INVENTION

### Summary of the Invention

Beginning with the main components of the present invention, the Rider of a first important embodiment of the publication package of the present invention consists of one or more pages of paper, cardboard, plastic, or other suitable material, upon which samples of products may be affixed, and upon which attractive marketing materials may be impressed. The Rider is designed to enclose, entirely or in part, a publication (typically, a magazine) to be delivered, and the Rider and publication tog ether may be held together while in transit by an outer cover or other suitable means.

The material of the Rider should be resilient enough, and durable enough, to withstand some rough treatment when the selected publication is injected into the hands of standard delivery services, such as the United States Postal Service. However, the resilience necessary in the

Rider material is reduced by the presence of the publication to be delivered, as the Rider encloses the publication, entirely or in part, so that bending of the Rider and publication is less likely than bending of the publication alone during transit. One the other hand, some increased stiffness and resilience in the Rider material, over the stiffness and resilience of the pages of a publication is desirable in some embodiments of the present invention, and in some cases relatively stiff material, which can be formed and set to hold a shape is desirable. Increased resilience, stiffness, the ability to hold a shape can, in many versions of the present invention, serve to provide a barrier between the sometimes fragile samples of products which accompany the publication using the Rider (and which are carried within the pages of the Rider), and the exterior of the Rider, from which shocks and stresses may be received during transit. The preferred embodiment of the present invention envisions lightweight cardstock, however all materials from which the backing may be made are within the scope of the present invention. As it is within the method of the present invention to utilize standard delivery services, it is desirable that such services test devices for delivering product samples such as may be delivered using the present invention, and the present invention has so been tested. Other postal riders developed by applicant herein have been tested and approved by the United States Postal Service.

The pages of the Rider are also intended to bear advertising in the usual course, although some versions of the Rider may be left blank, or merely colored attractively, or bear printing. The pages of the Rider should therefore be generally of a kind which accepts high quality printing and graphics. Such printing and graphics may be consistent with the exterior appearance of the publication to be delivered. In fact, all of the advertising appearing on the front and back of the Rider pages may also be coordinated with the advertising on the outer cover of the publication. With proper planning, product samples, including but not limited to sachets samples, may also be coordinated with the front and back covers of the publication to be delivered, thereby insuring overall aesthetic appeal of the selected publication.

Single-message, single-product, multiple-message, and multiple-product advertising is all possible using the numerous pages of the Rider, as is coordination with the publication itself. With multiple-message, multiple-product advertising, for instance, two or more product samples, bearing different brand names and graphics may be affixed to one page of the Rider, or on different pages of the Rider. The product manufacturer may then also arrange for its advertising, including the same name and graphics to appear on the highly desirable back cover of the publication, or the inside front cover of the publication, to thereby provide multiple exposures of such brand names and graphics. The same brand names and graphics, or different brand names and graphics, may be impressed on various pages of the Rider, separate from the product samples, or even under the product samples.

These advertising materials may be combined in the Rider with other promotional mechanisms, mechanisms such as coupons for purchase of full size containers of the products contained in the sample packages. The consumer is thereby provided with the product sample itself (or perhaps multiple samples of the same or different products), and attractive advertising materials which reinforce the desirability of the product as a sample. The consumer is also thereby provided with attractive advertising which reinforces the desirability of the product should the consumer find the regular, fuller sized, product on a shelf, or order the regular, fuller sized product for delivery. The consumer is also thereby provided with coupons, which allow the consumer to purchase the product or products at a reduced price one or more times, thereby inducing the consumer to seek out the product or products for purchase, at reduced price or at full price.

The effect of receiving product samples, viewing attractive advertising which relates to those samples on the pages of the Rider, and even receiving promotional items such as coupons, cannot be overstated. The overall Rider “package,” a combination of marketing elements, is well calculated to impress product manufacturer brands and graphics on consumers, only beginning with an initial (free) trial use by way of a product sample. The combination of marketing elements also produces a memorable experience for the user, recognition of the products on shelves, searching for products when shopping, and eventual purchase of full sizes of the marketed products. The impact of the Rider with the publication is to induce a sale not just once, but multiple times as a consumer develops loyalty based on such use, and the impact of such attractive, coordinated, repetitive, and memorable marketing. The Rider of the present invention provides maximum advertising impact for product manufacturers, only beginning when a consumer detaches sample packages from the Rider pages for inspection and use. Those Rider pages reinforce the product manufacturer's marketing message when the manufacturer's product are affixed to Rider pages, on a Rider which accompanies a consumer-selected publication, a publication which may be a “favorite” (but is in any case likely purchased in a paid for subscription).

In the usual course, the Rider of the present invention, along with the publication to be delivered, is contained within an outer cover during transit, and upon delivery. Other means for holding the Rider and publication together are possible, but an outer cover provides unique opportunities, for additional marketing “impact.” The outer cover fills a number of beneficial purposes, beginning with its function of keeping the Rider and the publication closely juxtaposed to one another, and not separate from one another during transit. In this function, the outer cover may be an integral part of the present invention because the outer cover maintains the position of the Rider as against the publication to be delivered. This position, in the normal course, maintains one or more pages of the Rider against some or all of the back cover of the publication, and maintains one or more pages of the Rider against some or all of the front cover of the selected publication. Once the outer cover is opened, therefore, the consumer is faced first with pages of the Rider, and only second with the covers of the publication.

The outer cover encloses the Rider and the publication entirely in a preferred embodiment of the present invention, and is composed of water-tight plastic. This choice of outer cover material also allows the outer cover to act as additional “padding,” and also a barrier to fluid leakage should one of the product sample packages break open during transit. This form of the outer cover insures against loss of product and also against spreading the product onto clothing or equipment, such as postal equipment or personnel. Since the outer cover is intended to be removed by a purchaser or consumer once the publication has been delivered, the outer cover thus remains in place surrounding the components of the publication package throughout transit by standard delivery means.

The covering means is in one preferred embodiment a thin and clear plastic “poly-bag.” In other embodiments, the covering means may be opaque, to hide the front and back covers of the publication, or to reinforce the branding of the publication or products within. In yet other embodiments, the thin and clear plastic may otherwise designed to fit around the combination of the Rider and the selected publication once these two pieces have been properly positioned one inside the other. With all such covering means, the Rider and the back cover of the selected publication (a magazine, for instance) may be held “in register,” so that the Rider and its affixed product samples are all held in position, one in relation to the other.

The unique opportunity afforded by the outer cover is one in which the outer cover provides for yet more marketing “impact.” That is, with the arrangement of outer cover, enclosing inner marketing pages (which carry sample packages), in turn enclosing the publication itself, consumers have an opportunity to view attractive marketing materials with each step of opening the packaging of the publication on its receipt. The product manufacturer thereby achieves a maximum of advertising space with the publication package of the present invention. All of the advertising space of the outer cover, and of the pages of the Rider, and the sample packages themselves, is viewable, and must even be handled as the consumer receives her publication. The consumer must therefore view any attractive advertising on the outer cover before opening it, and must then view the attractive advertising on the pages of the Rider before the publication is removed from the Rider.

The consumer is also given the opportunity to read the names of the product manufacturers on the product samples attached to the Rider, and pull them from the Rider for use (or for seeing again and again if then set aside, and not immediately used). The consumer is also given the opportunity to view the attractive advertising on the inside (or front side) of the back page (or pages) of the Rider when the publication has been removed from the Rider, and also view the attractive advertising on the back side of the first and back pages of the Rider before disposal of the Rider. In other words, all pages of the Rider are viewable to the consumer, and most of such pages must be viewed during the process of opening the outer cover, and separating the Rider “package” from the delivered publication. Other means of the Rider and the delivered publication together during transit provide some other advantages, so long as each such means comply with the requirements imposed by standard delivery service suppliers. However, using an opaque, printable, outer cover of the kind described above, with Rider-coordinated marketing imprinted thereon, along with a Rider and publication as described above, creates an overall effect which is a multi-sensual, multi-temporal, exposure, and a marketing “experience” for consumers.

The material of the Rider may be shaped in a variety of forms, with various benefits to be derived from each such form. While the Rider need not be as large in overall dimension (or any one dimension) than the publication to be delivered, preferred embodiments of the Rider of the present invention envision at least two Rider “pages” which are as long as the publication itself. This length is effectively the largest useful (length) dimension, as the Rider may be vulnerable to bending, and falling out of compliance with U.S. Postal Service regulations, if the Rider is substantially longer than the publication to be delivered. At the same time, a length approximately matching the publication to be delivered is the smallest desirable (length) dimension, as the area of each page of the Rider is increased as the length of the Rider is increased (up to the length of the publication), regardless of the width of such pages (and delivery services, including the U.S. Postal Service, do not charge more for longer, wider, or multiple Rider pages).

The width of the Rider pages may vary, depending on the purpose of the delivery, the number and kind of sample packages to be delivered, and the character of the marketing graphics to be presented. Printing large, sophisticated graphics, for instance, implies wider pages, as wider pages allow larger and visually prominent graphics and names. Wider pages also generally allow wider packages, accumulation of more packages on a single page (generally the inside of the first page of the Rider), and also “layering” of sample packages to increase the density of packages in any single mailing. However, additional marketing “impact” may be achieved by forming a page of the Rider (usually the first page) narrower, either by folding it, or by forming it at some width less than full publication width. In such case, the first page of the Rider will open to the left, with the fold between Rider front and back pages near the spine of the publication, thereby exposing the left portion of the front cover of the publication as the consumer opens the Rider. Such narrower widths of the first page may be beneficially combined with another narrow page, folded around the other edge of the publication, from the back page of the Rider. In such case, the extension of the back page of the Rider will open to the right, with the fold of Rider between the back page and the extension near the free edges of the pages of the publication, thereby exposing the right portion of the front cover of the publication as the consumer opens the Rider. The effect of using such “half pages” (less than full width pages, which may be halves, thirds, fourths, etc), is like the effect one achieves when one opens French doors, to more dramatically expose the view (in this case of the publication) beyond or within.

In some embodiments of the Rider, the folds between pages may be doubled. That is, two folds, near where pages would normally join at a single fold, will provide a long, narrow area, between pages. This narrow area may be sized to match the thickness of the publication, so the edge of the publication (the “spine” or other opening edges of the publication) may be positioned against the narrow area, before the font page of the Rider is folded over the front cover of the publication. However, the Rider of the present invention does not require such a double fold to be fully operable.

Also, the coupons which can be provide to consumers using the rider of the present invention may be designed into the pages of the Rider, both visually and by texture. For instance, coupons may be more easily removed from the pages of the Rider if those pages are perforated along lines which assist in easy tearing of the pages. Other textural modifications and additions are possible, either in the Rider pages themselves or in textural “add ons” which are affixed to the Rider pages like the product samples are affixed to the Rider pages.

As we have noted herein, delivery services, including the U.S. Postal Service, often charge a base amount, or a flat rate, for deliver of a publication, at least up to a certain weight. The Rider of the present invention takes advantage of this by including delivery of product samples, and delivery of additional advertising space, within that certain weight. However, advertisers can achieve even more with a Rider which has multiple pages. After all, the publication is multiple pages to begin with, and the rider merely adds pages to those of the publication. Each such additional Rider page presents yet another opportunity to present to the consumer additional attractive advertising (graphics and names), and supply the consumer with additional product samples. By planning the form of the Rider given the size of the publication, a user can “maximize” the advertising and samples, while still remaining under a target weight (and additional delivery charge). A user can also form the Rider with additional lighter pages with advertising, or fewer heavier pages with more samples, and the user can form the Rider and publication to exceed a planned weight, to achieve additional benefits in marketing and samples, if and as delivery companies, including the U.S. Post Office, charge a minimal “surcharge” for weights over their own usual publication postal rate.

During manufacture, the Riders of the present invention have affixed to them the product samples. The means for affixation may be as simple as staples or rivets, or even cuts in the pages about the width of the sample packages. However, the preferred affixation for most purposes is affixation with a measured amount of warmed, slightly sticky, adhesive. The best adhesive is one which is sticky and strong enough to hold each product sample securely to the pages of the Rider, but also allow a consumer to easily remove the product samples from those pages. A number of removable adhesive “dots” or “putty” will fill these requirements, however whatever the material, the location of the applied adhesive on the Rider pages must be planned, as the location of the adhesive will determine the location of the product samples. The location of the product samples, in turn, must be coordinated with the location and character of the advertising materials (graphics and names).

To increase the density of the product samples adhering to the pages of the Rider of the present invention, the Rider adhesive may be positioned so as to contact only a portion of product samples. Thus, a single product sample may be positioned on a page of the Rider with adhesive only at the upper portion of edge of the product sample, and a second product sample positioned to reside partially over the top of the first product sample (an “overlap” of the bottom edge of the second sample over a the top edge of the first sample). To make assembly of the Rider more complicated, many adhesives are applied hot or warm, and so require the positioning of product samples on the pages of the Rider before the adhesive cools. All of the challenges associated with positioning and product samples to the pages of the Rider of the present invention, so that they adhering to those pages, yet can be easily removed by a consumer, have been solved in the Rider of the present invention.

During manufacture, the pages of the Rider of the present invention are printed with text and graphics which relate to the products to be delivered in the product sample packages, and may also relate to the name and character of the publication to the delivered. As noted above, the product manufacturers create sample packages of their products, while the publication publisher plans the size and content of the publication to be delivered. The company which supplies the Rider (the “user” of the Rider) often coordinates its efforts with both the product manufacturers and the publisher, often first planning the number of sample packages to be delivered in light of the weight requirements of both product manufacturers and publisher. The user of the Rider may also then plan the attractive marketing materials, coupons, or other graphic and textural elements which will be printed on the pages of the Rider, in such fashion as to reinforce or augment the name and graphics of both product manufacturers and publisher. The Rider user may then receive product sample packages from the product manufacturers, and join the product samples to the pages of the Rider, using the appropriate adhesive, consistent with the marketing plans of both manufacturers and publisher. The Rider user may then receive copies of the finished publication from the publisher, position the publication within the Rider, enclose the Rider (with affixed product sample packages) and publication in the outer cover, and deliver the finished assembled “pieces” to the company selected to make the delivery.

While the Rider of the present invention provides a facility for holding product sample packages within the Rider, such product sample packages are not themselves part of the present invention. However, in some cases, sample packages may be specially formed to fit in certain locations on the pages of the Rider, or may be formed in sizes which are specially suited to delivery utilizing the Rider of the present invention. Since such “special purpose” product sample packages are usable only with the Rider of the present invention, they are part of, and an adjunct to, this Rider invention.

[FIGS. 1-5] In a first embodiment of the present invention, the Rider of the present invention is formed with only two full pages. This embodiment may also be formed with a narrow double fold, as described above, thereby creating a long, narrow space between the folds of the double fold, against which the one edge (generally, the spine) of the publication to be delivered may be positioned. On the outside of the first page of the Rider, and on the inside and outside of the back page of the Rider, attractive marketing materials of one product manufacturer are impressed. The user of the Rider assembles the finished Rider employing the coordinated information from a single product manufacturer and the publisher of the publication described above. In that assembly, numerous product sample packages, received from that product manufacturer, in various sizes, are affixed to the inside of the first page of the Rider, using an appropriate adhesive. To increase the density of such packages, some of the packages are overlapped using the off-center placement of adhesive described above. The front and back pages of the Rider (and any additional pages of the Rider added as described herein) creates an additional “protective” barrier between sample packages within the Rider and external forces which may impact the Rider from its exterior.

[FIGS. 1, 2A-5A] In another embodiment of the present invention, the Rider of the present invention is formed with only one full page, and another full page which has been folded approximately in half lengthwise, in the process described above. This embodiment may also be formed with a narrow double fold, as described above, thereby creating a long, narrow space between the folds of the double fold, against which the one edge (generally, the spine) of the publication to be delivered may be positioned. On the outside of the first page of the Rider, attractive marketing materials of one product manufacturer are impressed, but in this embodiment, the fold near the center of the first page of the Rider may act as a divider. On either side of that divider, different advertising materials of one product manufacturer may be impressed, or advertising material of two or more manufacturers may be impressed. The folding of the front page, or the back page, of the Rider creates an interesting visual complexity on the front of the first page of the Rider. This folding (and any additional pages of the Rider added as described herein) also creates an opportunity for an additional “protective” barrier between sample packages within the Rider and external forces which may impact the Rider from its exterior. On the inside and outside of the back page of the Rider, attractive marketing materials of one product manufacturer are impressed. The user of the Rider assembles the finished Rider employing the coordinated information from a single product manufacturer, or from multiple product manufacturers, along with the publisher of the publication described above. In that assembly, numerous product sample packages, received from that product manufacturer, or those product manufacturers, in various sizes, are affixed to the inside of the first page of the Rider, using an appropriate adhesive. When opening the first page of the Rider in this embodiment, the folded first page is opened while folded, and then the first page is unfolded to reveal product samples on either side of the first page fold. With this configuration, the products of multiple product manufacturers can be naturally displayed, and carried to a consumer folded within the first page of the Rider, or attached to any inside surface of the Rider.

Publishers and product manufacturers can appreciate the marketing benefit in the Rider of the present invention, as the delivery of each issue can be reduced as publishers and product manufacturers each pick up some of the delivery costs. At the same time, the U.S. Postal Service provides a rate for “riders” generally which, in many cases, would allow the delivery of sample packages for free, or very little cost. This “break” in price for riders generally, and the Rider of the present invention specifically, allows the user of the Rider of the present invention to offer discounts in delivery costs to both product manufacturers and to publishers. Product manufacturers also gain, as noted above, by putting their product (at least in the form of samples) directly into the hands of potential consumers, so that such consumers can seek out such products in the future, and become loyal purchasers.

At the same time, publishers and product manufacturers gain by additional product exposure, and by close association of desirable products, in the form of samples of such products which accompany such desirable publications. Each party in this transaction increases the desirability and value of their product and publication by this close association. This close association is enhanced by the construction of the Rider of the present invention, as the consumer first sees his or her favorite publication, delivered to his or her door. The outer cover of the publication may be opaque, and bear the name of the publisher's publication, and likely some attractive graphics, printed on its exterior. The outer cover may also be translucent, thereby allowing the consumer to see both the name of the publication on the outer cover, and the name of the product manufacturers through the outer cover.

When the outer cover is opaque, in particular, the consumer is exposed multiple times, in an active process, whereby the consumer first sees the publisher's publication name (for instance, the magazine “Elle”) on the exterior of the outer cover, then sees the name or names of product manufacturers (for instance, “Olay”) on the front of the first page of the Rider (or on the outside of the back page of the Rider). The consumer then opens the outer cover, to reveal the name of the product to be sampled on the front of the first page of the Rider.

In the “folded cover” embodiment of the Rider, the consumer may also see both the name of the publication (on the right side of the magazine, where the first page of the Rider is folded back toward the spine of the magazine) and the name of the product of the product manufacturer which will be sampled (over the left side of the magazine, where the folded back first page of the Rider covers the front of the magazine).

In all embodiments of the Rider of the present invention, the consumer may the open out the first page of the Rider to view the inside of the first page of the Rider on the left, and the front cover of the publication on the right. The consumer may then remove the publication from the Rider, generally by sliding it to the right, while leaving the Rider in place. Once the publication is removed, the inside of the back page of the Rider is also viewable, so the consumer may see additional names and graphics thereon. The material on the inside of the back page of the Rider may be additional attractive marketing material by the same product manufacturer already seen, or a different attractive marketing material supplied by a different product manufacturer. In fact, each page, and each portion of a page, of the Rider may be used by different product manufacturers.

With the publisher's publication close by, the consumer may separate one or more product sample packages from one or more pages of the Rider, open one or more product sample packages, and apply the contents of the sample package, the sample itself, to skin, hair, nails, clothing, or to such other surface as is intended for such product samples. The “experience” thereby created, with (for instance) fragrance freshly applied, attractive marketing materials on the pages of the Rider, and perhaps the delivered publication in view, “surrounds” the consumer, employing with multiple senses, with exceptional impact.

The more important features of the invention have thus been outlined, rather broadly, so that the detailed description thereof that follows may be better understood, and in order that the present contribution to the art may be better appreciated. Additional features of specific embodiments of the invention will be described below. However, before explaining preferred embodiments of the invention in detail, it may be noted briefly that the present invention substantially departs from pre-existing apparatus and methods of the prior art. In so doing, the present invention provides publishers with the highly desirable ability to add marketing images and texts to their publications and, at the same time, provides product manufacturers with the highly desirable ability to deliver samples of their products to targeted potential customers. Further, the design of the present invention allows a user to design special equipment to automate the process of constructing riders and publication packages consistent with such design, and such equipment which may then be used to “scale” production to provide such riders and packages in very large batches and runs.

### Objects of the Invention

One object of this invention is to provide a publication “rider,” which may be used for distributing sample products and promotional materials.

Another object of this invention is to provide such a Rider that may accompany a magazine or any other publication of any size (including a large size, such as with a catalogue), that is, of any width, length, or thickness.

Another object of the present invention is to provide such a Rider adapted for use in distributing sample materials to a selected sample of the public, therefore providing an efficient utilization of marketing resources, in a targeted marketing campaign.

Another object of the present invention is to provide such a product sample Rider that may be economically produced in mass quantities, to thereby reach large numbers of consumer in such targeted marketing campaign.

Another object of the present invention is to provide such a Rider that may hold product sample packages in a variety of lengths, and widths, so that different volumes of product may be delivered with such publication, and in which such product containers may be formed to hold fluids intended for delivery.

Another object of the present invention is to provide such a Rider that may hold product sample packages in a variety of lengths, and widths, so that a large number of product samples may be carried on the Rider, either separated from one another, or overlapping to increase density.

Another object of the present invention is to provide such a Rider that may be used with a variety of publications.

Another object of the present invention is to provide such a Rider that may be distributed by a publisher or advertiser with products which are consistent with the theme of the subject publication, and coordinated with its advertising.

Another object of the present invention is to provide such a Rider that fits alongside the binding of the publication, or alongside any similar edge of the publication, allowing copies of the publication to be easily stacked without damaging the Rider or the publication, and at the same time allow the publication to be folded, or rolled into a tube, and to be inserted in any USPO approved mail box.

Another object of the present invention is to provide such a Rider with outer cover that may be formed of a clear plastic which allows for easy and quick identification of the particular products delivered in the Rider, thereby providing both increased impact on potential consumers as well as additional incentive for prospective newsstand customers to purchase the publication.

Another object of the present invention is to provide such a Rider with outer cover that may be formed of an opaque plastic which allows for clear printing of the publication title and graphics, consistent with the publication inside the outer cover, and multiple-step process of opening the outer cover of the package to view the Rider therewithin and, upon removing the publication from the Rider, various sample product packages and associated graphics, which may all be coordinated with the publication which has been delivered.

Another object of the present invention is to provide such a Rider, holding product samples and promotional materials that may act as incentives to purchase the subject publication over other publications on display, therefore increasing the sales of the publication.

Another object of the present invention is to provide such a Rider that consists of pages composed of material which is durable and resilient, thereby enhancing protection of the product samples delivered in the Rider as well as an effective means of protecting the products and product containers from tampering.

Another object of the present invention is to provide such a Rider having a backing formed of high quality material, most suitable for printing high quality images and texts, which may be keyed to the graphics of the delivered publication, and to the product samples themselves, in ways which create exceptional, one-of-a-kind advertising impact.

Another object of the present invention is to provide such a Rider in which the Rider pages are first separated from the selected publication. This separation exposes a consumer or subscriber to the pages of the Rider, much as she would be exposed to the front cover of the publication, thereby allowing the graphics on the Rider pages, which are coordinated to the graphics of the sample packages, to lead the consumer naturally to the samples to be delivered in the Rider. This also allows the eyes of the consumer to linger over the high impact images on the pages of the Rider until the consumer turns to remove the sample packages.

Another object of the present invention is to provide a Rider that is, when joined with a selected publication, in compliance with all U.S. Postal Service regulations.

### BRIEF DESCRIPTION OF DRAWINGS

The accompanying drawings, which are incorporated in and constitute a part of this specification, illustrate preferred embodiments of the present invention, and such drawings, together with the description set forth herein, serve to explain the principles of the invention.

FIG. 1 is a perspective view drawing of a first preferred embodiment of the postal Rider of the present invention, viewed from the front cover. The publication to be delivered is shown positioned within an opaque publication package poly-bag wrap outer cover, which bears the name of the publication to be delivered (here, the magazine titled “Elle”).

FIG. 2 is a perspective view drawing of the same first preferred embodiment of the Rider appearing in FIG. 1, viewed from the outside of the first page of the Rider, within which the delivered publication, with side and bottom page edges, is viewable. The name of the product of one product manufacturer (here, the fragrance product “Olay”) appears on that first page of the Rider.

FIG. 3 is a perspective view drawing of the same first preferred embodiment of the Rider appearing in FIGS. 1 and 2, viewed from the front cover of the delivered publication, and the inside of the first page of the Rider. Also apparent on the inside of the first page of the Rider are product sample packages bearing the same brand as appeared on the outside of the first page of the Rider.

FIG. 4 is a perspective view drawing of the same first preferred embodiment of the Rider appearing in FIGS. 1, 2, and 3, viewed from the front cover of the delivered publication, and the inside of the first page of the Rider, in which the delivered publication is partially removed from the Rider.

FIG. 5 is a perspective view drawing of the same first preferred embodiment of the Rider appearing in FIGS. 1, 2, 3, and 4, viewed from the inside of the Rider, with delivered publication removed, product sample packages bearing the same brand as appeared on the outside of the first page of the Rider apparent on the inside of the first page of the Rider, and additional name and graphics of the product manufacturer apparent on the inside of the back page of the Rider.

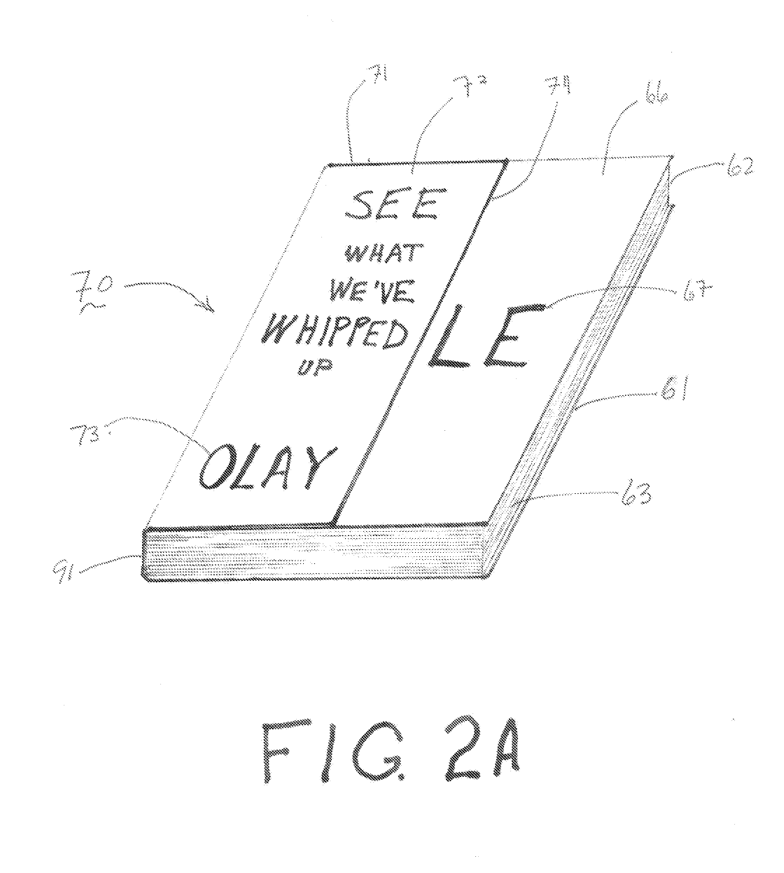

FIG. 2A is a perspective view drawing of a second preferred embodiment of the Rider of the present invention, viewed from the outside of the first page of the Rider, within which the delivered publication, with side and bottom page edges, is viewable. The name of the product of one product manufacturer (here, the fragrance product “Olay”) appears on a folded over left half of the first page of the Rider, while the name of the publication (here, the magazine titled “Elle”), is viewable on the right side of the same cover, where the first page of the Rider does not extend.

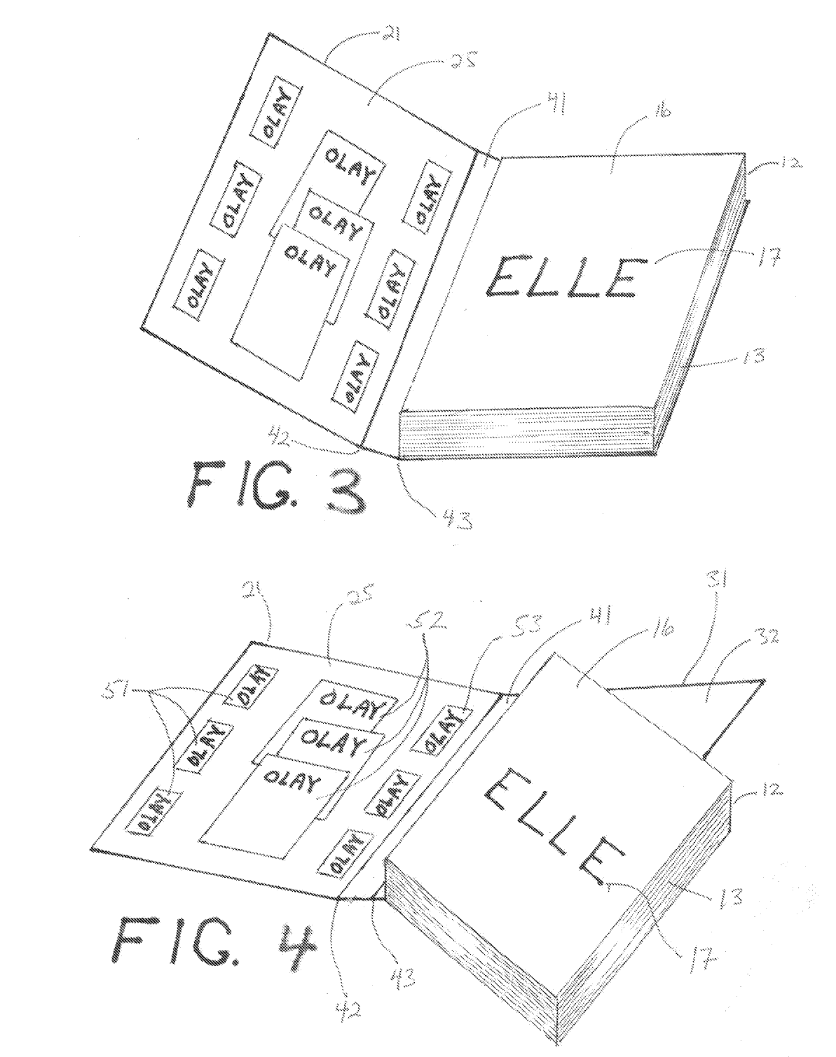

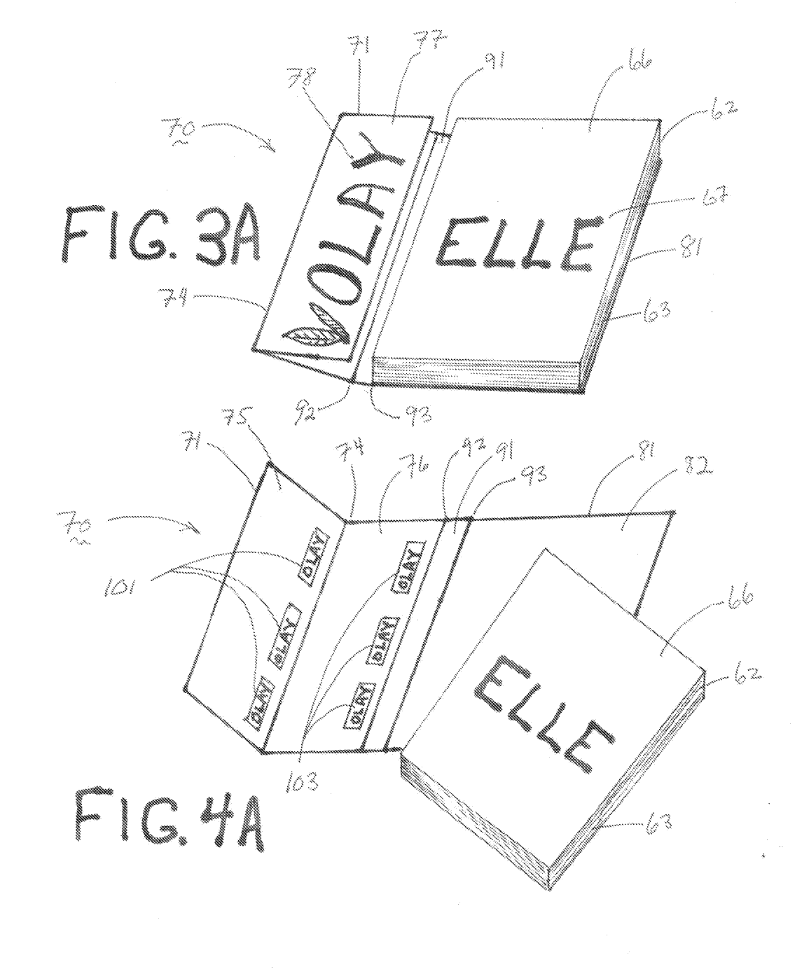

FIG. 3A is a perspective view drawing of the same second preferred embodiment of the Rider appearing in FIG. 2A, viewed from the front cover of the delivered publication, and the outside of (folded over) half of the first page of the Rider. Also apparent on the outside of the first page of the Rider is the name of the product manufacturer and its attractive graphics.

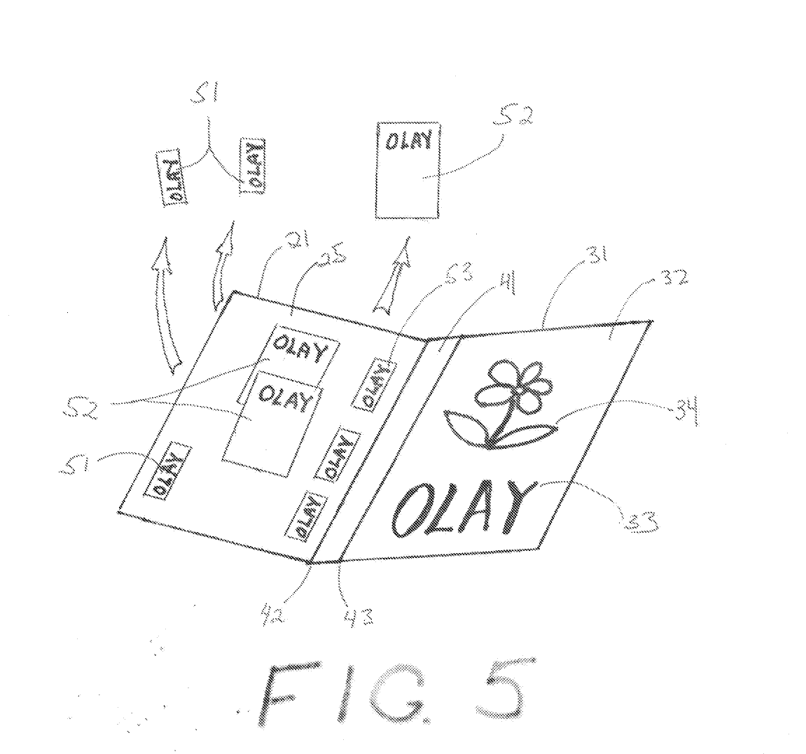

FIG. 4A is a perspective view drawing of the same second preferred embodiment of the Rider appearing in FIGS. 2A, and 3A, viewed from the front cover of the delivered publication, and the inside of the first page of the Rider, in which the publication is partially removed from the Rider.

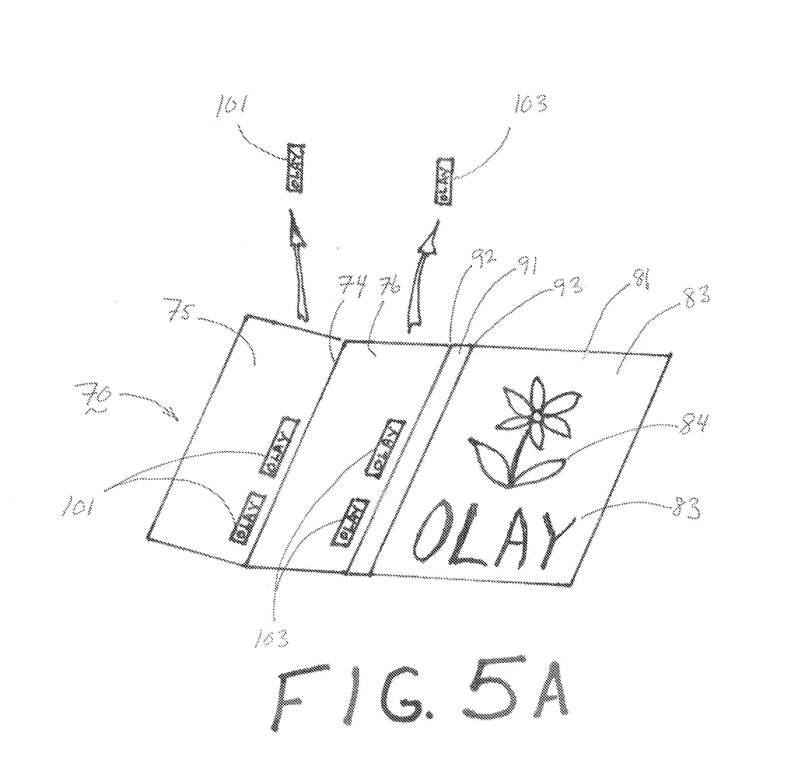

FIG. 5A is a perspective view drawing of the same second preferred embodiment of the Rider appearing in FIGS. 2A, 3A, and 4A, viewed from the inside of the Rider, with delivered publication removed. The first page of the Rider is now fully opened (no longer folded), product sample packages bearing the same brand as appeared on the outside of the first page of the Rider are apparent on the inside of the first page of the Rider, and additional name and graphics of the product manufacturer are apparent on the inside of the back page of the Rider.

### DETAILED DESCRIPTION OF EMBODIMENT

### First Preferred Embodiment

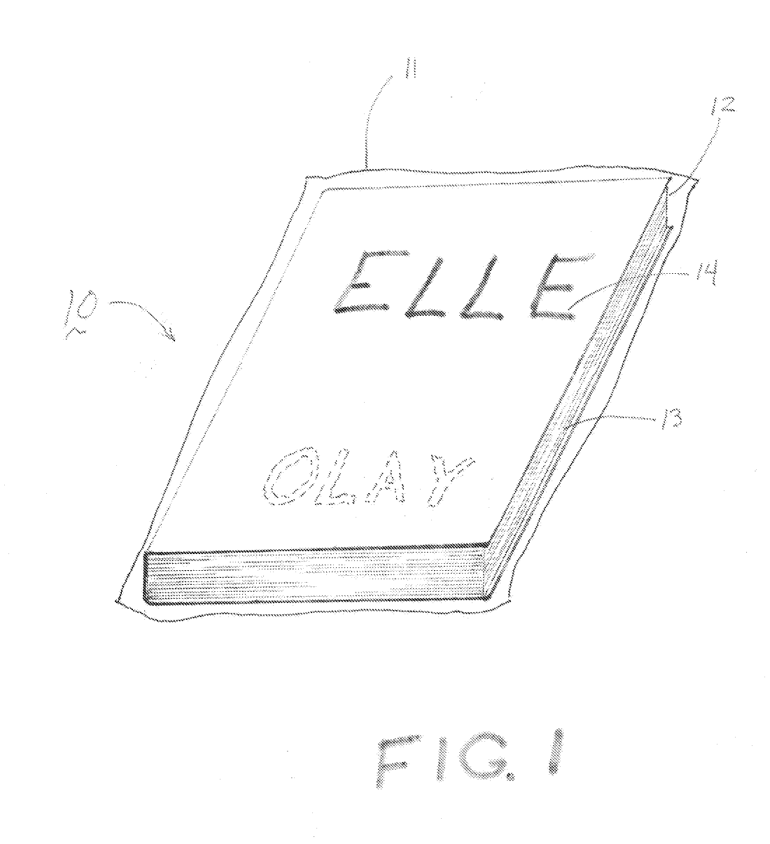

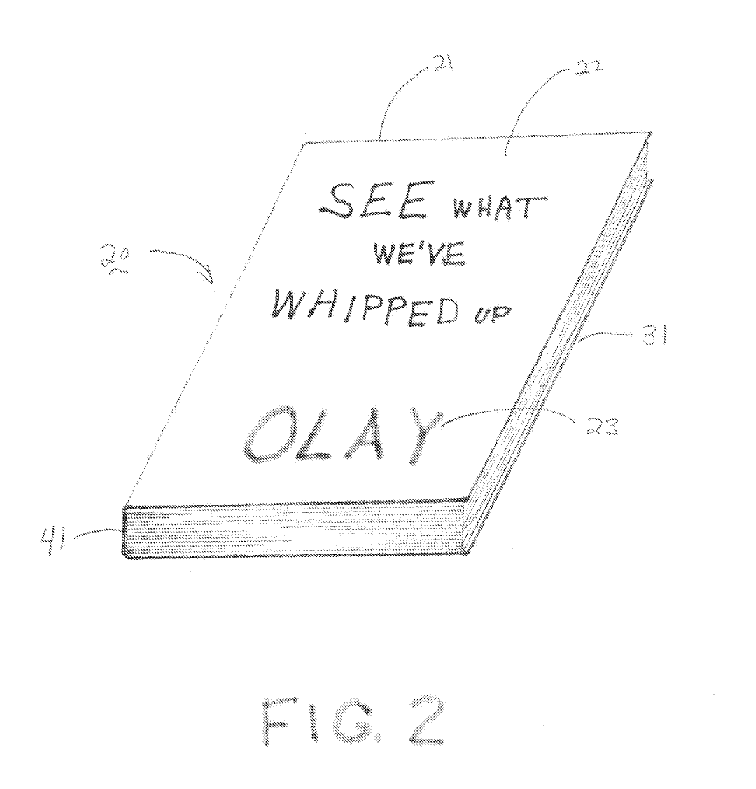

Referring initially to FIG. 1, a first embodiment of full publication package 10 of the present invention is shown in perspective, as it has been wrapped in plastic outer cover 11. The outer cover 11 may be wrapped around the contents within outer cover 11, or outer cover 11 may be more loosely fitting around such contents, so long as the material and configuration of the outer cover complies with U.S. Postal Service requirements. In FIG. 1, various components of publication package 10 may be viewed through outer cover 11, however those components may not be accessed until such time as outer cover 11 is removed from publication package 10. Moreover, although the contents within outer cover 11 may be seen in FIG. 1, a second, and preferred, configuration for outer cover 11, is opaque to visual inspection. With an opaque outer cover 11, the outer cover may bear the name of a publisher's publication contained within, and likely some attractive graphics, printed on the exterior of the publication. Outer cover 11 may also be translucent, thereby allowing the consumer to see both the name of a publisher's publication on outer cover 11, and the names of one or more product manufacturers through translucent outer cover 11. Using an opaque, printable, outer cover 11 of the kind described above, with coordinated marketing imprinted thereon, along with a publisher's publication contained therein, as described above and herein, a user may create an overall effect which is a multi-sensual, multi-temporal, exposure, and a marketing “experience” for consumers.

FIG. 1 shows (in this case) an opaque, printable, outer cover 11 of the kind described above, with coordinated marketing imprinted thereon. Within outer cover 11 of FIG. 1, we may see the position of a publication selected by a publisher for distribution, in this case magazine 12, with its pages 13 (only page edges visible). While the position of magazine 12 is apparent in FIG. 1, magazine 12 is not visible to a consumer because of opaque outer cover 11. As noted above, the exterior of opaque outer cover 11 may carry titles and graphics which compliment, and coordinate with, other similar graphics within the publication package. That coordinated marketing begins with the printed title 14 of the magazine 12 contained within outer cover 11, in this case the title 14 of the magazine known as “Elle,” on the exterior of outer cover 11. We may also see the position of one or more names of products which may be joined with magazine 12 within outer cover 11, as those names (in this case the name “Olay”) may be imprinted on the first page of the publication rider of the present invention. Again, that position, and those names. is and are not apparent to the consumer before opening outer cover 11 of the publication rider of the present invention.

In FIG. 2, we see the publication rider 20 of the present invention (the “Rider”). Since outer cover 11 has been removed, we may now directly see the first page 21 of Rider 20, with its outside 22 of first page 21 bearing lettering and other graphics. We may also see the magazine 12 of FIG. 1, and its pages 13 (only page edges visible). With outer cover 11 removed, we may see that magazine 12 is covered, front and back, and along the “spine” of magazine 12, by Rider 20. On outside 22 of first page 21 of Rider 20, we may now also see directly (because outer cover 11 has been removed) the one or more names 23 (in this case the name “Olay”) of one of the products which may be joined by, or carried together by, Rider 20 with magazine 12 within outer cover 11 of the publication package of the present invention. In this case, once outer cover 11 has been removed, the consumer may also see, along with the name “Olay,” other attractive marketing materials, such as attractive graphics, and exhortations such as “SEE what we've WHIPPED up.”

In FIG. 2 we also see the edge of back page 31 of Rider 20 (the front and back of back page 31 are not visible in FIG. 2, as magazine 12 sits on the front of back page 31), and we see the edge of the long, narrow space 41 between the folds of the double fold near the center of Rider 20, against which narrow space 41 one edge of magazine 12 may be positioned. In this first embodiment of the present invention, Rider 20 is formed with only two full pages, first page 21 and back page 31, and narrow space 41 between the double fold between those two full pages. However, it is within the scope of the present invention to form Rider 20 with one or more additional pages between first page 21 and back page 31. Such additional pages may also have a double fold to, in effect create a “book” of pages, all having a narrow space like narrow space 41 between such double folds. It is also within the scope of the present invention to form Rider 20 without such double folds so that first page 21 and back page 31 are adjacent, with no long, narrow space (like narrow space 41) between them. It is also within the scope of the present invention to form Rider 20 with one or more additional pages between first page 21 and back page 31, without such long, narrow space, again creating a “book” of pages without a narrow space like narrow space 41. All such “books” of pages of Rider 20 may be held together with glue, or staples, or other means, should the application make fastened pages desirable, however the pages of the “books” of Rider 20 may also be held proximate to each other without such fastening between them, as all such pages, plus magazine 12 are held together in transit by outer cover 11.

In FIG. 3, we again see Rider 20, and magazine 12, with its pages 13, that we see in FIG. 1 and FIG. 2. However, in FIG. 3, first page 21 of Rider 20 has been opened, and swung away to the left side of magazine 12, to reveal the inside 25 of first page 21 of Rider 20. We also see the front side of magazine 12 front cover 16, with the title 14 (in this case, the title “Elle”) of magazine 12 appearing thereon. This is the same title we saw on the front of outer cover 11 in FIG. 1. Thus, a consumer opening the publication package of the present invention will have observed the title of magazine 12 on outer cover 11, and then will have observed the names or brands of one or more products 23 (in this case, products from “Olay”) which appear on the front side 22 of the first page 21 of Rider 20, and then will again have observed the title of magazine 12 on the front side of magazine 12 front cover 16 when first page 21 of Rider 20 is swung away from the front side of magazine 12 front cover 16. Having been initially exposed to the name or brands of one or more products in the process of opening the publication package, and repeatedly exposed to the title of magazine 12 within Rider 20, in that process, the consumer is then again presented with an opportunity to sample those one or more products, because sample packages of such products are presented to the consumer on the inside 25 of first page 21 of Rider 20 once first page 21 is swung away from magazine 12 front cover 16. In the process of swinging first page 21 of Rider 20 away from magazine 12, we also see the long, narrow area 41 between first page 21 of Rider 20, and the last page of Rider 20 (which last page cannot be seen in FIG. 3, as it is positioned below magazine 12). Long, narrow area 41, which is particular to this embodiment, but not necessary to all embodiments, was created by the double folds 42 and 43, referred to here, in the pages of the Rider 20.

In FIG. 4, we again see Rider 20, and magazine 12, with its pages 13, that we see in FIG. 1 and FIG. 2 and FIG. 3. However, in FIG. 4, magazine 12 has been partially removed from the position its occupies, against long, narrow area 41, within Rider 20, while the publication package of the present invention was in transit. On inside 25 of first page 21 of Rider 20, various specific product sample packages 51, 52, and 53, may also be seen. The user of Rider 20 has assembled the finished Rider 20 employing the coordinated information from one or more product manufacturers, and the publisher of the publication described above. In that assembly, various product sample packages 51, 52, and 53, affixed to inside 25 of first page 21 of Rider 20, are received from that or those product manufacturers, in various sizes, and affixed to the inside of the first page of Rider 20, using an appropriate adhesive. To increase the density of various product sample packages 51, 52, and 53, three product sample packages 52 are, in this embodiment, overlapped while affixed, using the off-center placement of adhesive as described above, near the center line of inside 25 of first page 21 of Rider 20. Three additional sample packages 51, in this case from the same product manufacturer as supplied sample packages 52, are affixed, using the same adhesive, near the left edge of inside 25 of first page 21 of Rider 20. Yet three more additional sample packages 53, in this case again from the same product manufacturer as supplied sample packages 52, are affixed, using the same adhesive, near the right edge of inside 25 of first page 21 of Rider 20. The front and back sides of the front and back pages of the Rider (and any additional pages of the Rider added as described herein) are all available to carry similar product sample packages, thereby allowing the density of sample packages to be greatly increased. However, the density of product sample packages a user may achieve using only the inside 25 of first page 21 of Rider 20, and the inside 32 of the last page 31 of Rider 20 (with such additional pages as the user finds appropriate or desirable), is sufficient for all marketing purposes. Additionally, the user will also achieve additional protection for the contents of all product sample packages using only the surfaces of the inside 25 of first page 21 of Rider 20, and the inside 32 of the last page 31 of Rider 20 (with such additional pages as the user finds appropriate or desirable), because the exterior pages of Rider 20 create additional “protective” barriers between sample packages within Rider 20 and external forces which may impact Rider 20 from its exterior.

In FIG. 5, we again see Rider 20 that we see in FIG. 1 and FIG. 2 and FIG. 3 and FIG. 4. However, in FIG. 5, the publication which was delivered has been entirely removed from the position its occupied, against long, narrow area 41, within Rider 20, while the publication package of the present invention was in transit. On inside 25 of first page 21 of Rider 20, various specific product sample packages 51, 52, and 53, having the coordinated information from one or more product manufacturers and the publisher of the publication described above, may again be seen. However, in FIG. 5, the consumer has now separated from inside 25 of first page 21 of finished Rider 20 some of the product sample packages 51 and 52, which were affixed to inside 25 of first page 21 of Rider 20. Other sample packages among sample packages 51 and 52 remain affixed to inside 25 of first page 21 of Rider 20, while all sample packages 53 remain so affixed. The consumer has therefore selected for use various sample packages 51 and 52 for immediate inspection and use, and left other sample packages for later use, or no use at all. On the inside 32 of last page 31 of Rider 20, we may also see the name of one product manufacturer 33 (in this case, the product manufacturer known as “Olay”), in this case the same product manufacturer we observed on the outside 22 of first page 21 of Rider 20, and on the exterior of the various specific product sample packages 51, 52, and 53 which are or were affixed to the inside 25 of first page 21 of Rider 20. On the inside 32 of last page 31 of Rider 20, we may also see attractive marketing graphics 34, which are coordinated throughout Rider 20 by the user, for the same product manufacturer (again “Olay”).

Referring again to FIG. 1, a second embodiment of a full publication package 10 of the present invention is shown in perspective, as it has been wrapped in plastic outer cover 11. Again, just as in the first embodiment set forth above, outer cover 11 may be shrink-wrapped around the contents within outer cover 11, or outer cover 11 may be more loosely fitting around such contents, so long as the material and configuration of the outer complies with U.S. Postal Service requirements. However, because of the construction of the second embodiment of the publication package, and in particular the second embodiment of the Rider contained within outer cover 11, various components of publication package 10, to the extent they may be viewed through outer cover 11, will appear different. Again those components may not be accessed until such time as outer cover 11 is removed from publication package 10. Moreover, as with the first embodiment noted above, a second, and preferred, configuration for outer cover 11, is opaque to visual inspection. With an opaque outer cover 11, the outer cover may again bear the name of a publisher's publication contained within, and likely some attractive graphics, printed on the exterior of the publication. And again, the opaque, printable, outer cover 11 of the kind described above, with coordinated marketing imprinted thereon, along with a publisher's publication contained therein, as described above and herein, allows a user to create an overall effect which is a multi-sensual, multi-temporal, exposure, and a marketing “experience” for consumers.

In FIG. 2A, we see the second embodiment of publication rider 70 of the present invention (the “Rider”). With outer cover 11 removed, we may see the magazine 62 to be delivered, and its pages 63 (only page edges visible). Since outer cover 11 has now been removed, we may now also directly see the first page 71 of Rider 70, with its outside 72 of first page 71 bearing lettering and other graphics. However, first page 71 of Rider 70 has been folded back, ether over or under, at and along fold line 74. With fold line 74, magazine 62 is covered, along its back, and along the “spine” of magazine 62, by Rider 70, however part of front cover 66 of magazine 62 is still visible. On outside 72 of first page 71 of Rider 70, we may again see directly (because outer cover 11 has been removed) the one or more names 73 (in this case the name “Olay”) of one of the products which may be joined by, or carried together by, Rider 70 with magazine 62. In this case, once outer cover 11 has been removed, the consumer may again see, along with the name “Olay,” other attractive marketing materials, such as attractive graphics, and exhortations such as “SEE what we've WHIPPED up.”

In FIG. 2A we also see the edge of back page 81 of Rider 70 (the front and back of back page 81 are not visible in FIG. 2, as magazine 62 sits on the front of back page 81), and we see the edge of the long, narrow space 91 between the folds of the double fold near the center of Rider 70, against which narrow space 91 one edge of magazine 72 may be positioned. In this second embodiment of the present invention, Rider 70 is formed with only two full pages, first page 71 and back page 81, and narrow space 91 between the double fold between those two full pages. However, it is within the scope of the present invention to form Rider 70 with one or more additional pages between first page 71 and back page 81. Such additional pages may also have a double fold to, in effect create a “book” of pages, all having a narrow space like narrow space 91 between such double folds. It is also within the scope of the present invention to form Rider 70 without such double folds so that first page 71 and back page 81 are adjacent, with no long, narrow space (like narrow space 91) between them. It is also within the scope of the present invention to form Rider 70 with one or more additional pages between first page 71 and back page 81, without such long, narrow space, again creating a “book” of pages without a narrow space like narrow space 91. All such “books” of pages of Rider 70 may be held together with glue, or staples, or other means, should the application make fastened pages desirable, however the pages of the “books” of Rider 70 may also be held proximate to each other without such fastening between them, as all such pages, plus magazine 62 are held together in transit by outer cover 11.

In FIG. 3A, we again see Rider 70, and magazine 62, with its pages 63, that we see in FIG. 2. However, in FIG. 3, first page 71 of Rider 70 has been opened, and swung away to the left side of magazine 62, to reveal second portion 77 of first page 71, which also carries printed upon it a product manufacturer's name (in this case, the product manufacturer “Olay” 78). We also see the front side of magazine 62 front cover 66, with the title 67 (in this case, the title “Elle”) of magazine 62 appearing thereon. This is the same title we saw on the front of outer cover 11 in FIG. 1. Thus, a consumer opening the publication package of the present invention will have observed the title of magazine 62 on outer cover 11, and then the names or brands of one or more products 73 (in this case, products from “Olay”) which appear on the front side 72 of the first page 71 of Rider 20, and then the names or brands of one or more products on second portion 77 of first page 71. The consumer then will again have observed the title of magazine 62 on the front side of magazine 62 front cover 66 when first page 71 of Rider 70 is swung away from the front side of magazine 62 front cover 66. In the process of swinging first page 71 of Rider 70 away from magazine 62, we also see the long, narrow area 91 between first page 71 of Rider 70, and the last page of Rider 70 (which last page cannot be seen in FIG. 3A, as it is positioned below magazine 62). Long, narrow area 91, which is particular to this embodiment, but not necessary to all embodiments, was created by the double folds 92 and 93, referred to here, in the pages of the Rider 70.

In FIG. 4A, we again see Rider 70, and magazine 62, with its pages 63, that we see in FIG. 2 and FIG. 3. However, in FIG. 4, magazine 62 has been partially removed from the position its occupies, against long, narrow area 91, within Rider 70, while the publication package of the present invention was in transit. In FIG. 4A, first page 71 is now fully opened along fold line 74, thereby exposing inside page portions 75 and 76. Having been initially exposed to the name or brands of one or more products in the process of opening the publication package, and repeatedly exposed to the title of magazine 62 within Rider 70 in that process, the consumer is in FIG. 4A now presented with an opportunity to sample those one or more products, because sample packages of such products are presented to the consumer on inside page portions 75 and 76 of first page 71. On inside page portions 75 and 76 of first page 71 of Rider 20, various specific product sample packages 101 and 103 may also be seen. The user of Rider 70 has assembled the finished Rider 70 employing the coordinated information from one or more product manufacturers, and the publisher of the publication described above. In that assembly, various product sample packages 101 and 103, affixed to inside page portions 75 and 76 of first page 71 of Rider 70, are received from that or those product manufacturers, in various sizes, and affixed to the inside page portions 75 and 76 of first page of Rider 70, using an appropriate adhesive. To increase the density of various product sample packages 101 and 103, product sample packages may be overlapped while affixed, using the off-center placement of adhesive as described above. However, in this second embodiment, product sample packages 101 and 103 are not shown so overlapped. In this second embodiment, in FIG. 4A, three sample packages 101 are affixed to inside page portion 75, using the same adhesive, near the right edge of inside page portion 75 of first page 71 of Rider 70. Three more additional sample packages 103, in this case again from the same product manufacturer as supplied sample packages 101, are affixed, using the same adhesive, near the right edge of inside page portion 76 of first page 71 of Rider 70. The front and back sides of the front and back pages of the Rider (and any additional pages of the Rider added as described herein) are all available to carry similar product sample packages, thereby allowing the density of sample packages to be greatly increased. However, the density of product sample packages a user may achieve using only the inside page portions 75 and 76 of first page 71 of Rider 70, and the inside 82 of the last page 81 of Rider 20 (with such additional pages as the user finds appropriate or desirable), is sufficient for all marketing purposes. Additionally, the user will also achieve additional protection for the contents of all product sample packages using only the surfaces of the inside page portions 75 and 76 of first page 71 of Rider 70, and the inside 82 of the last page 81 of Rider 70 (with such additional pages as the user finds appropriate or desirable), because the exterior pages of Rider 70 create additional “protective” barriers between sample packages within Rider 70 and external forces which may impact Rider 70 from its exterior.

In FIG. 5A, we again see Rider 70 that we see in FIG. 2A and FIG. 3A and FIG. 4A. However, in FIG. 5A, the publication which was delivered has been entirely removed from the position its occupied, against long, narrow area 91, within Rider 70, while the publication package of the present invention was in transit. On inside page portions 75 and 76 of first page 71 of Rider 70, various specific product sample packages 101 and 103, having the coordinated information from one or more product manufacturers and the publisher of the publication described above, may again be seen. However, in FIG. 5A, the consumer has now separated from inside page portions 75 and 76 of first page 71 of finished Rider 70 some of the product sample packages 101 and 102, which were affixed to inside 75 of first page 71 of Rider 70. Other sample packages among sample packages 101 and 102 remain affixed to inside page portions 75 and 76 of first page 21 of Rider 20. The consumer has therefore selected for use various sample packages 101 and 102 for immediate inspection and use, and left other sample packages for later use, or no use at all. On the inside 82 of last page 81 of Rider 70, we may also see the name 83 of one product manufacturer (in this case, the product manufacturer known as “Olay”), in this case the same product manufacturer we observed on the outside 72 of first page 71 of Rider 70, and on the exterior of the various specific product sample packages 101 and 103 which are or were affixed to the inside page portions 75 and 76 of first page 71 of Rider 70. On the inside 82 of last page 81 of Rider 70, we may also see attractive marketing graphics 84, which are coordinated throughout Rider 70 by the user, for the same product manufacturer (again “Olay”).

Other embodiments will be apparent to those skilled in the art from consideration of the specification and practice of the invention disclosed herein. It is intended that the specification and examples be considered as exemplary only, with a true scope of the invention being indicated by the following claims and equivalents.

What is claimed is:

1. A publication package comprising:
a publication having pages, the publication pages having a length and a width, the publication pages having page edges around their periphery, the publication pages join along a spine of the publication,
a rider formed of material durable and resilient enough to resist bending, to thereby hold objects affixed to the material of the rider,
the rider having a length of approximately equal to the length of the publication pages, and a width approximately twice as wide as the width of the publication pages,
The rider having a rider first fold extending the length of the rider, and positioned approximately half way along the width of the rider, the rider first fold forming a generally flat rider first page, and a generally flat rider second page,
the rider first page having a front side and a back side, the rider second page having a front side and a back side,
at least one product sample package affixed to the back side of the rider first page, or affixed to the front side of the rider second page,
the publication is positioned between the rider first page and the rider second page, so that the publication is situated next to the at least one rider fold, and
an outer cover which encloses the publication, and the rider with the at least one product sample package affixed to the rider first page or the rider second page.

2. The publication package of claim 1 further comprising a rider second fold, extending the length of the rider and parallel to the rider first fold, and positioned approximately half way along the width of the rider, the rider second fold is separated from the rider first fold, the rider first fold and rider second fold forming a generally flat rider first page, and a generally flat rider second page, and a generally flat narrow area between the rider first page and the rider second page, and the publication is positioned near the generally flat narrow area between the rider first page and the rider second page.

3. The publication package of claim 1 further comprising at least one rider additional page, the at least one rider additional page formed of material durable and resilient enough to resist bending, to thereby hold objects affixed to the material of the rider third page, the at least one rider additional page having a front side and a back side, the at least one rider additional page affixed along one of its edges to the rider near its rider first fold.

4. The publication package of claim 3 further comprising at least one product sample package affixed to the back side of the rider third page, or affixed to the front side of the rider third page.

5. The publication package of claim 1 further comprising first page indicia printed on the front side of the rider first page.

6. The publication package of claim 5 further comprising back page indicia printed on the front side of the rider second page.

7. The publication package of claim 5 further comprising product sample package indicia printed on the at least one product sample package, in which the product sample package indicia is coordinated with the rider first page indicia.

8. A publication package comprising:
a publication having pages, the publication pages having a length and a width, the publication pages having page edges around their periphery, the publication pages join along a spine of the publication,
a rider formed of material durable and resilient enough to resist bending, to thereby hold objects affixed to the material of the rider,
the rider having a length of approximately equal to the length of the publication pages, and a width approximately twice as wide as the width of the publication pages,
the rider having a rider first fold and a rider second fold, the rider first and second folds are parallel, and extend the length of the rider,
the rider first fold positioned approximately half way along the width of the rider, the rider first fold forming a generally flat rider first page, and a generally flat rider second page,
the rider second fold positioned approximately half way along the width of the generally flat rider first page, thereby folding the generally flat rider first page approximately in half,
the rider first page having, when folded, a front side first approximately half page, and a front side second approximately half page, and a back side first approximately half page, and a back side second approximately half page,
the rider second page having a front side and a back side,
at least one product sample package affixed to the rider first page back side first approximately half page, or affixed to the rider first page back side second approximately half page,
the publication is positioned between the rider folded first page and the rider second page, so that the publication is situated next to the rider first fold, and
an outer cover which encloses the publication, and the rider with the at least one product sample package affixed to the rider first page back side first or second approximately half pages.

9. The publication package of claim 8 further comprising a rider third fold, extending the length of the rider, and parallel to the rider first fold, and positioned approximately half way along the width of the rider, the rider third fold separated from the rider first fold, the rider first fold and rider third fold forming a generally flat rider first page, and a generally flat rider second page, and a generally flat narrow area between the rider first page and the rider second page, and the publication is positioned near the generally flat narrow area between the rider first page and the rider second page.

10. The publication package of claim 8 further comprising at least one rider additional page, the at least one rider additional page formed of material durable and resilient enough to resist bending, to thereby hold objects affixed to the material of the rider third page, the at least one rider additional page having a front side and a back side, the at least one rider additional page affixed along one of its edges to the rider near the rider first fold.

11. The publication package of claim 10 further comprising at least one product sample package affixed to the back side of the at least one rider additional page, or affixed to the front side of the at least one rider additional page.

12. The publication package of claim 8 further comprising first page indicia printed on the front side first approximately half page, and on the front side second approximately half page.

13. The publication package of claim 8 further comprising back page indicia printed on the front side of the rider second page.

14. The publication package of claim 12 further comprising product sample package indicia printed on the at least one product sample package, in which the product sample package indicia is coordinated with the rider first page indicia.

15. A publication package comprising:
a publication having pages, the publication pages having a length and a width, the publication pages having page edges around their periphery, the publication pages join along a spine of the publication,
a rider formed of material durable and resilient enough to resist bending, to thereby hold objects affixed to the material of the rider,
the rider having a length of approximately equal to the length of the publication pages, and a width at least twice as wide as the width of the publication pages,
the rider having a rider first fold and a rider second fold, the first and second rider folds are parallel, and extend the length of the rider,
the rider first fold is positioned on the rider less than half way along the width of the rider, the rider first fold forming a generally flat rider first page, and a generally flat rider second page,
the rider second fold is positioned on the rider approximately the width of the publication from the rider first fold, the rider second fold forming a generally flat rider third page joined to the rider second page.
the rider first page having a front side and a back side, the rider second page having a front side and a back side, the rider third page having a front side and a back side,
at least one product sample package affixed to the back side of the rider first page, or affixed to the front side of the rider second page, or affixed to the back side of the rider third page,
the publication is positioned between the rider first page and the rider second page, so that the publication is situated over the rider second page, and between the rider first fold and the rider second fold,
the rider first page and rider third page are closed over the publication as it sits on the rider second page, and
an outer cover which encloses the publication, and the rider with the at least one product sample package affixed to the rider first page or the rider third page.

16. The publication package of claim 15 further comprising at least one rider additional page, the at least one rider fourth page formed of material durable and resilient enough to resist bending, to thereby hold objects affixed to the material of the at least one rider additional page, the at least one rider additional page having a front side and a back side, the at least one rider additional page affixed along one of its edges to the rider near the rider first fold or the rider second fold.

17. The publication package of claim 16 further comprising at least one product sample package affixed to the back side of the at least one rider additional page, or affixed to the front side of the at least one rider additional page.

18. The publication package of claim 15 further comprising first page indicia printed on the front side of rider first page, and third page indicia printed on the front side of rider third page.

19. The publication package of claim 15 further comprising back page indicia printed on the front side of the rider second page.

20. The publication package of claim 18 further comprising product sample package indicia printed on the at least one product sample package, in which the product sample package indicia is coordinated with the rider first page indicia and the rider third page indicia.
